(19) United States
(12) Patent Application Publication
(10) Pub. No.: US 2012/0165242 A1
(43) Pub. Date: Jun. 28, 2012

(54) POLYMERS FOR HIGH-SURFACTANT FORMULATIONS

(76) Inventors: Sze-Sze Ng, Midland, MI (US); Qichun Wan, Midland, MI (US); Christopher J. Tucker, Midland, MI (US); Eric C. Greyson, Blue Bell, PA (US); Marianne Creamer, Warrington, PA (US); Joseph Manna, Quakertown, PA (US); Jan Edward Shulman, Newtown, PA (US)

(21) Appl. No.: 13/329,490

(22) Filed: Dec. 19, 2011

Related U.S. Application Data
(60) Provisional application No. 61/427,247, filed on Dec. 27, 2010.

(51) Int. Cl. C11D 3/37

(52) U.S. Cl. 510/476

(57) ABSTRACT

A detergent composition having at least two components. The first component is from 14 to 50 wt % surfactants. The second component is from 0.05 to 4 wt % of a polymer which has polymerized residues of 40 to 65 wt % C₁-C₁₈ alkyl (meth)acrylates and 25 to 55 wt % C₃-C₆ carboxylic acid monomers.

### BACKGROUND

This invention generally relates to an improved high-surfactant detergent formulation comprising acrylic polymers.

Polymers made from acrylic acid monomers, including higher alkyl monomers are known as additives for laundry detergents. For example, U.S. Pub. No. 2008/0306218 discloses a polymer comprising polymerized residues of methacrylic acid, ethyl acrylate, a C₁₂-polyethylene glycol ester of methacrylic acid and lauryl methacrylate. However, the prior art does not disclose a high-surfactant detergent composition according to the present invention which gives superior results.

The problem solved by the present invention is to provide an improved high-surfactant detergent composition comprising acrylic polymers.

### STATEMENT OF THE INVENTION

The present invention is directed to a detergent composition comprising: (a) from 14 to 50 wt % surfactants; and (b) from 0.05 to 4 wt % of at least one polymer comprising polymerized residues of: (i) 40 to 65 wt % C₁-C₁₈ alkyl (meth)acrylates; wherein at least 1/10 by weight of the C₁-C₁₈ alkyl (meth)acrylates is limited to C₄-C₁₈ alkyl (meth)acrylates; (ii) 25 to 55 wt % C₃-C₆ carboxylic acid monomers; and (iii) 0 to 20 wt % of monomers of structure H₂C═C(R)C(O)X(CH₂CH₂O)ₙ(CH(R′)CH₂O)ₘR″ or H₂C═C(R)C₆H₄C(CH₃)₂NHCO₂(CH₂CH₂O)ₙ(CH(R′)CH₂O)ₘR″; wherein X is O or NH, R is H or CH₃, R′ is C₁-C₂ alkyl; R″ is C₈-C₂₅ alkyl, C₈-C₁₆ alkylphenyl or C₁₃-C₃₆ aralkylphenyl; n is an average number from 6-100 and m is an average number from 0-50, provided that n≧m and m+n is 6-100.

### DETAILED DESCRIPTION OF THE INVENTION

All percentages are weight percentages (wt %) and all fractions are by weight, unless otherwise indicated and all temperatures are in ° C., unless otherwise indicated. Measurements made at “room temperature” (room temp.) were made at 20-25° C. Weight average molecular weights, M_{w}, are measured by hydrolyzing polymers, filtering insoluble material, and then performing gel permeation chromatography (GPC) using polyacrylic acid standards, as is known in the art. The techniques of GPC are discussed in detail in Modern Size Exclusion Chromatography, W. W. Yau, J. J. Kirkland, D. D. Bly; Wiley-Interscience, 1979, and in A Guide to Materials Characterization and Chemical Analysis, J. P. Sibilia; VCH, 1988, p. 81-84. The molecular weights reported herein are in units of daltons. As used herein the term “(meth)acrylic” refers to acrylic or methacrylic. A “C₃-C₆ carboxylic acid monomer” is a mono-ethylenically unsaturated compound having one or two carboxylic acid groups, e.g., (meth)acrylic acid, maleic acid, fumaric acid, itaconic acid, maleic anhydride, crotonic acid, etc. Alkyl groups are saturated hydrocarbyl groups which may be straight or branched. Aralkyl groups are alkyl groups substituted by aryl groups. Examples of aralkyl groups include, e.g., benzyl, 2-phenylethyl and 1-phenylethyl. Aralkylphenyl groups are phenyl groups having one or more aralkyl substituents, e.g., 2,4,6-tris(1-phenylethyl)phenyl.

Preferably, the polymer is an acrylic polymer, i.e., one having at least 50 wt % polymerized residues of acrylic monomers, preferably at least 70 wt %, preferably at least 80 wt %, preferably at least 90 wt %, preferably at least 95 wt %, preferably at least 98 wt %. Acrylic monomers include (meth)acrylic acids and their C₁-C₂₅ alkyl or hydroxyalkyl esters, including monomers of structure H₂C═C(R)CO₂(CH₂CH₂O)ₙ(CH(R′)CH₂O)ₘR″; crotonic acid, itaconic acid, fumaric acid, maleic acid, maleic anhydride, (meth)acrylamides, (meth)acrylonitrile and alkyl or hydroxyalkyl esters of crotonic acid, itaconic acid, fumaric acid or maleic acid. The acrylic polymer may also comprise other polymerized monomer residues including, e.g., non-ionic (meth)acrylate esters, cationic monomers, H₂C═C(R)C₆H₄C(CH₃)₂NHCO₂(CH₂CH₂O)ₙ(CH(R′)CH₂O)ₘR″, H₂C═C(R)C(O)X(CH₂CH₂O)ₙ(CH(R′)CH₂O)ₘR″, monounsaturated dicarboxylates, vinyl esters, vinyl amides (including, e.g., N-vinylpyrrolidone), sulfonated acrylic monomers, vinyl sulfonic acid, vinyl halides, phosphorus-containing monomers, heterocyclic monomers, styrene and substituted styrenes. Preferably, the polymer contains no more than 5 wt % sulfur- or phosphorus-containing monomers, preferably no more than 3 wt %, preferably no more than 2 wt %, preferably no more than 1 wt %. Preferably, the polymer has a weight average molecular weight (M_{w}) of at least 150,000, preferably at least 180,000, preferably at least 200,000, preferably at least 300,000. In some cases, especially when the polymer crosslinked, the M_{w} can be extremely high, e.g., as high as 10,000,000. Preferably, the M_{w} is no greater than 5,000,000, preferably no greater than 2,000,000, preferably no higher than 1,000,000.

Preferably, the detergent composition comprises 35 to 85 wt % water. Preferably, the detergent composition comprises at least 40 wt % water, preferably at least 45 wt %, preferably at least 50 wt %, preferably at least 60 wt %. Preferably, the detergent composition comprises no more than 80 wt % water, preferably no more than 70 wt %, preferably no more than 60 wt %, preferably no more than 50 wt %, preferably no more than 45 wt %, preferably no more than 40 wt %. Preferably, the detergent composition is a liquid or gel at 20° C.

The surfactant(s) may be cationic, anionic, nonionic, fatty acid metal salt, zwitterionic or betaine surfactants. Preferably, the surfactant comprises at least one surfactant selected from anionic and nonionic surfactants. Preferably, nonionic surfactants have an alkyl group having at least eight carbon atoms and at least five polymerized ethylene oxide or propylene oxide residues. Preferably, anionic surfactants have an alkyl group having at least ten carbon atoms and an anionic group, preferably selected from sulfonates and carboxylates. Anionic surfactants also may have polymerized residues of ethylene oxide, and/or may have aromatic rings, e.g., linear alkylbenzene sulfonates. Some anionic surfactants are fatty acid alkali metal salts. Preferably, the detergent composition comprises at least 15 wt % surfactants, preferably at least 17 wt %, preferably at least 20 wt %, preferably at least 25 wt %, preferably at least 30 wt %, preferably at least 35 wt %, preferably at least 40 wt %. Preferably, the detergent composition comprises no more than 46 wt % surfactants, preferably no more than 42 wt %, preferably no more than 38 wt %, preferably no more than 34 wt %. Preferably, the detergent composition comprises at least 6 wt % linear alkylbenzene sulfonates, preferably at least 8 wt %, preferably at least 10 wt %, preferably at least 12 wt %, preferably at least 14 wt %. Preferably, the detergent composition comprises no more than 20 wt % linear alkylbenzene sulfonates, preferably no more than 18 wt %, preferably no more than 16 wt %. Preferably, a formulation for hand dishwashing contains 5-25% alkyl ethoxylate sulfates (AEOS), preferably 10-22%, preferably 15-20%; and a total surfactant level from 15-30%, preferably from 15-25%. Optionally, the formulation may contain alkyl amine oxide surfactants.

In some embodiments, preferably when the detergent composition contains no more than 25 wt % surfactant, at least 3/10 of the C₁-C₁₈ alkyl (meth)acrylates in the polymer is limited to C₄-C₁₈ alkyl (meth)acrylates, preferably at least 4/10, preferably at least 5/10; and preferably the C₁-C₁₈ alkyl (meth)acrylates are limited to C₁-C₈ alkyl (meth)acrylates and the C₄-C₁₈ alkyl (meth)acrylates are limited to C₄-C₈ alkyl (meth)acrylates, preferably C₄-C₈ alkyl acrylates preferably butyl acrylate (BA). In some embodiments, these limitations are present when the detergent composition contains no more than 20 wt % surfactant.

The detergent composition contains from 0.05 to 4 wt % of at least one polymer, calculated on a polymer solids basis relative to the entire weight of the detergent. Preferably, the detergent composition contains at least 0.2 wt % of the polymer(s), preferably at least 0.3 wt %, preferably at least 0.4 wt %, preferably at least 0.5 wt %, preferably at least 0.6 wt %, preferably at least 0.8 wt %. Preferably, the detergent composition contains no more than 3.5 wt % of the polymer(s), preferably no more than 3 wt %, preferably no more than 2.5 wt %, preferably no more than 2 wt %, preferably no more than 1.5 wt %. If more than one polymer is present, the total amount of such polymers is within the above limits The detergent composition may also contain 5 to 30 wt %, preferably 8 to 20 wt % of other ingredients, e.g., solvents (e.g., propylene glycol, ethanol; typically 1 to 12 wt %), fragrances, enzymes, rheology modifiers, salts (e.g., sodium citrate), polycarboxylates dispersants, synthetic clay (e.g., Laponite), sodium/potassium (bi)carbonate and/or (di)silicate and other chelants, e.g., methylglycine N,N-diacetic acid (MGDA), glutamic acid N,N-diacetic acid (GLDA), 2-hydroxyethyliminodiacetic acid (HEIDA) or their salts, e.g., the sodium salts.

Preferably, the polymer comprises at least 42 wt % polymerized residues of C₁-C₁₈ alkyl (meth)acrylates, preferably at least 44 wt %, preferably at least 46 wt %, preferably at least 48 wt %, preferably at least 50 wt %, preferably at least 52 wt %, preferably at least 55 wt %, preferably at least 58 wt %. Preferably the polymer comprises no more than 62 wt % polymerized residues of C₁-C₁₈ alkyl (meth)acrylates, preferably no more than 60 wt %, preferably no more than 55 wt %, preferably no more than 52 wt %, preferably no more than 50 wt %. Preferably, the C₁-C₁₈ alkyl (meth)acrylate residues are limited to C₁-C₁₂ alkyl (meth)acrylate residues, preferably C₄-C₁₂ alkyl methacrylate or C₁-C₁₂ alkyl acrylate residues, preferably C₁-C₈ alkyl (meth)acrylate residues, preferably C₄-C₈ alkyl methacrylate or C₁-C₈ alkyl acrylate residues, preferably C₁-C₆ alkyl (meth)acrylate residues, preferably C₄-C₆ alkyl methacrylate or C₁-C₆ alkyl acrylate residues, preferably C₂-C₁₂ alkyl (meth)acrylate residues, preferably C₄-C₁₂ alkyl methacrylate or C₂-C₁₂ alkyl acrylate residues, preferably C₁-C₈ alkyl acrylate residues, preferably C₂-C₈ alkyl acrylate residues. Preferably, at least 2/10 by weight of the C₁-C₁₈ alkyl (meth)acrylates is limited to C₄-C₁₈ alkyl (meth)acrylates, preferably at least 3/10, preferably at least 4/10, preferably at least 5/10. Preferably, at least 2/10 by weight of the C₁-C₁₈ alkyl (meth)acrylates is limited to C₄-C₈ alkyl (meth)acrylates, preferably at least 3/10, preferably at least 4/10, preferably at least 5/10. Preferably, the polymer contains no more than 15 wt % polymerized residues of (meth)acrylate esters that are not C₁-C₁₈ alkyl (meth)acrylates, preferably no more than 10 wt %, preferably no more than 7 wt %, preferably no more than 4 wt %.

Preferably, the polymer comprises at least 27 wt % polymerized residues of C₃-C₆ carboxylic acid monomers, preferably at least 30 wt %, preferably at least 33 wt %, preferably at least 36 wt %, preferably at least 38 wt %, preferably at least 40 wt %. Preferably, the polymer comprises no more than 50 wt % polymerized residues of C₃-C₆ carboxylic acid monomers, preferably no more than 48 wt %, preferably no more than 45 wt %, preferably no more than 40 wt %, preferably no more than 35 wt %. Preferably, the C₃-C₆ carboxylic acid monomer is a C₃-C₄ carboxylic acid monomer; preferably (meth)acrylic acid, preferably methacrylic acid (MAA). Preferably, the polymer comprises no more than 30 wt % of polymerized residues of acrylic acid (AA), preferably no more than 28 wt %, preferably no more than 26 wt %, preferably no more than 22 wt %.

Preferably, when the polymer comprises at least 15 wt % polymerized residues of methyl acrylate, the polymer comprises at least 45 wt % polymerized residues of C₁-C₁₈ alkyl (meth)acrylates, preferably at least 50 wt %, preferably at least 55 wt %. Preferably, when the polymer comprises at least 25 wt % polymerized residues of methyl acrylate, the polymer comprises at least 50 wt % polymerized residues of C₁-C₁₈ alkyl (meth)acrylates, preferably at least 55 wt %, preferably at least 60 wt %. Preferably, when the polymer comprises at least 25 wt % polymerized residues of methyl acrylate, the polymer comprises at least 10 wt % polymerized residues of acrylic acid, preferably at least 12 wt %, preferably at least 14 wt %, preferably at least 16 wt %.

Preferably, the polymer contains no more than 18 wt % of polymerized residues of monomers of structure H₂C═C(R)C(O)X(CH₂CH₂O)ₙ(CH(R′)CH₂O)ₘR″ or H₂C═C(R)C₆H₄C(CH₃)₂NHCO₂(CH₂CH₂O)ₙ(CH(R′)CH₂O)ₘR″, preferably no more than 15 wt %, preferably no more than 12 wt %, preferably no more than 10 wt %, preferably no more than 8 wt %, preferably no more than 6 wt %, preferably no more than 4 wt %, preferably no more than 2 wt %. In the monomers of structure H₂C═C(R)C(O)X(CH₂CH₂O)ₙ(CH(R′)CH₂O)ₘR″ or H₂C═C(R)C₆H₄C(CH₃)₂NHCO₂(CH₂CH₂O)ₙ(CH(R′)CH₂O)ₘR″, preferred C₈-C₂₅ alkyl (meth)acrylates are the C₁₂-C₂₂ alkyl (meth)acrylates, preferably C₁₆-C₂₂ alkyl (meth)acrylates, preferably C₁₂-C₁₈ alkyl (meth)acrylates. Typically, in monomers having structure H₂C═C(R)C(O)X(CH₂CH₂O)ₙ(CH(R′)CH₂O)ₘR″, X is O; R″ is C₈-C₂₅ alkyl, preferably C₁₂-C₂₂ alkyl, preferably C₁₆-C₂₂ alkyl; n is 15-30 and m is 0-5; preferably n is 18-25 and m is 0-3; preferably n is 18-25 and m is 0-2; and R′ and R are methyl. Preferably, the polymer contains no more than 10 wt % of polymerized residues of monomers that are not acrylic monomers, preferably no more than 7 wt %, preferably no more than 5 wt %, preferably no more than 2 wt %.

The polymer may be a crosslinked polymer, that is, a crosslinker, such as a monomer having two or more non-conjugated ethylenically unsaturated groups, is included with the copolymer components during polymerization. Preferred examples of such monomers include, e.g., di- or tri-allyl ethers and di- or tri-(meth)acrylyl esters of diols or polyols (e.g., trimethylolpropane diallyl ether (TMPDE), ethylene glycol dimethacrylate), di- or tri-allyl esters of di- or tri-acids, allyl (meth)acrylate, divinyl sulfone, triallyl phosphate, divinylaromatics (e.g., divinylbenzene). Preferably, the amount of polymerized crosslinker residue in the polymer is no more than 0.3 wt %, preferably no more than 0.2 wt %, preferably no more than 0.1 wt %, preferably no more than 0.05 wt %, preferably no more than 0.02 wt %, preferably no more than 0.01 wt %.

Preferably, the polymer is provided as an aqueous composition containing the polymer as discrete particles dispersed in an aqueous medium. In this aqueous dispersion, the average particle diameter of the polymer particles is typically in the range of from 20 to 1,000 nm, preferably in the range of from 50 to 500 nm, and more preferably, in the range of from 75 to 350 nm Particle sizes herein are those determined using a Brookhaven Model BI-90 particle sizer manufactured by Brookhaven Instruments Corporation, Holtsville, N.Y., reported as “effective diameter”. The level of polymer particles in the aqueous dispersion is typically in the range of from 15 to 60 wt %, preferably 20 to 50 wt %, based on the weight of the aqueous dispersion.

Preferably, the pH of a liquid laundry detergent composition is adjusted to be in the range of 6 to 12, preferably from 6.5 to 10.5, preferably 7 to 10, preferably from 8 to 10, preferably from 8 to 9.5. Suitable bases to adjust the pH of the formulation include mineral bases such as sodium hydroxide and potassium hydroxide; ammonium hydroxide; and organic bases such as mono-, di- or tri-ethanolamine. Mixtures of bases may be used. Suitable acids to adjust the pH of the aqueous medium include mineral acid such as hydrochloric acid, phosphorus acid, and sulfuric acid; and organic acids such as acetic acid. Mixtures of acids may be used. The formulation may be adjusted to a higher pH with base and then back titrated to the ranges described above with acid.

Suitable polymerization techniques for use in the method of this invention include emulsion polymerization and solution polymerization, preferably emulsion polymerization. Aqueous emulsion polymerization processes typically are conducted in an aqueous reaction mixture, which contains at least one monomer and various synthesis adjuvants such as the free radical sources, buffers, and reductants in an aqueous reaction medium. Optionally, a chain transfer agent is used to limit molecular weight, preferably a mercaptan, preferably a C₈-C₁₂ alkyl mercaptan (e.g., n-dodecylmercaptan, nDDM); preferably no more than 0.5% chain transfer agent is used. The aqueous reaction medium is the continuous fluid phase of the aqueous reaction mixture and contains greater than 50 weight % water and optionally one or more water miscible solvents, based on the weight of the aqueous reaction medium. Suitable water miscible solvents include methanol, ethanol, propanol, acetone, ethylene glycol ethyl ethers, propylene glycol propyl ethers, and diacetone alcohol. Preferably, the aqueous reaction medium contains greater than 90 weight % water, and more preferably, greater than 95 weight % water, based on the weight of the aqueous reaction medium. Most preferred is an aqueous reaction medium containing from 98 to 100 weight % water, based on the weight of the aqueous reaction medium.

The polymer may be produced by a thermal initiated method in which the polymerization occurs in the presence of a thermal oxidant, preferably using the sodium, ammonium, potassium salts of persulfates.

The polymer may be produced by a redox method in which at least 30% of polymerization occurs in the presence of an oxidant, a reductant and a metal catalyst, and substantially in the absence of a peroxide, hydroperoxide or perester containing an alkyl group having at least five carbon atoms. The redox systems use one or more oxidants in combination with a suitable reductant and a metal catalyst. Preferably, at least 40 wt % of total monomer is polymerized in the presence of the redox system, preferably at least 50 wt %, preferably at least 60 wt %, preferably at least 70 wt %, preferably at least 80 wt %. The total weight of monomers includes any monomer which already has been polymerized at the time the redox system is added. Suitable oxidants include, e.g., t-alkyl hydroperoxides, t-alkyl peroxides, and t-alkyl peresters, wherein in each case the t-alkyl group has fewer than 5 carbon atoms; hydrogen peroxide, sodium peroxide, potassium peroxide, persulfate, percarbonate, perborate, perphosphoric acid and salts thereof, potassium permanganate, and ammonium or alkali metal salts of peroxydisulfuric acid. Preferred oxidants include persulfate, percarbonate and perborate; preferably persulfate. In the method of this invention, polymerization occurs substantially in the absence of a peroxide, hydroperoxide or perester containing an alkyl group having at least five carbon atoms. Herein, the phrase “substantially in the absence” means that the oxidant contains less than 5 wt % of peroxides, hydroperoxides or peresters having C₅ or larger alkyl groups, preferably less than 2 wt %, preferably less than 1 wt %, preferably less than 0.5 wt %, preferably less than 0.1 wt %, preferably 0 wt %. Preferably, polymerization is conducted substantially in the absence of any peroxides, hydroperoxides or peresters. Preferably, oxidants are present at a total level of from 0.01 to 1 wt %, based on the total weight of the monomers, preferably from 0.03 to 0.5 wt %, preferably from 0.05 to 0.25 wt %. Suitable reductants include sodium sulfoxylate formaldehyde, ascorbic acid, isoascorbic acid, alkali metal and ammonium salts of sulfur-containing acids, such as sodium sulfite, bisulfite, thiosulfate, hydrosulfite, sulfide, hydrosulfide, dithionite, formadinesulfinic acid, hydroxymethanesulfonic acid, sodium 2-hydroxy-2-sulfinatoacetic acid, acetone bisulfite, amines such as ethanolamine, acids such as glycolic acid, glyoxylic acid hydrate, lactic acid, glyceric acid, malic acid, tartaric acid, and salts of the preceding acids. Preferably the reductant is isoascorbic acid. Preferably, reductants are present at a total level of from 0.01 to 1 wt %, based on the total weight of the monomers preferably from 0.03 to 0.4 wt %, preferably from 0.05 to 0.2 wt %. Suitable metal catalysts are redox reaction catalyzing metal salts including, e.g., iron, copper, manganese, silver, platinum, vanadium, nickel, chromium, palladium, and cobalt. Preferred metal catalysts are selected from iron, copper and combinations thereof; preferably iron. Preferably, metal catalysts are present at a total level of at least 0.1 ppm, based on metal ion content in the total weight of the monomers, preferably at least 0.5 ppm, preferably at least 1 ppm, preferably at least 2 ppm, preferably at least 3 ppm, preferably at least 4 ppm; preferably the metal catalysts are present at a total level no greater than 100 ppm, preferably no greater than 50 ppm, preferably no greater than 25 ppm, preferably no greater than 20 ppm. The total weight of monomers includes any monomer which already has been polymerized at the time the oxidant, reductant and metal ion are added. When the part of the polymerization reaction catalyzed by oxidant, reductant and metal ion is conducted in contact with equipment containing catalytic metals, e.g., steel reactors, it may not be necessary to add additional metal ion with the other reactants. In some preferred embodiments of the invention, a portion of the monomer mixture is partially polymerized using an oxidant as the intiator, followed by addition of the remaining monomer and polymerization in the presence of an oxidant, a reductant and a metal catalyst. Preferably, less than 50 wt % of total monomer is polymerized using a thermal oxidant, preferably less than 25 wt %, preferably less than 15 wt %, preferably less than 10 wt %. This thermally polymerized material can be formed in situ at the beginning of the polymerization, or from a previously prepared polymer seed, or as the result of a “chaser” addition. Additionally, the polymerization could be started using a redox process (oxidant/ reductant/ and metal catalyst), the second stage employing a thermal process. The redox portion of the process can be a gradual feed, a shot, a feed followed by a shot, or a shot followed by a feed, or other possible combinations. A shot addition is one in which monomer is added over a relatively short time, e.g., less than 20 minutes, preferably less than 15 minutes, preferably less than 10 minutes, so that the reaction mixture will contain substantial unreacted monomer after the addition. Typically, shot additions contain only monomer, with catalysts being added to the reaction mixture separately, preferably after the shot addition. After most of the polymerization is complete, i.e., at least 85%, preferably at least 90%, preferably at least 95%; additional initiators may be added as a “chaser” to polymerize most of the residual monomer. The chaser may be a thermal initiator or a redox system.

A typical redox polymerization is exemplified as follows for preparation of polymer N. To a one liter round bottom flask, equipped with a mechanical stirrer, heating mantle, thermocouple, condenser and inlets for the addition of monomer, initiators and nitrogen was charge 271.2 grams deionized water. The mixture was set to stir and heated to 45° C. The reaction was sparged with nitrogen for 1 hour prior to start of polymerization. Monomer cofeed solution was prepared by charging 5.78 grams of 28% sodium lauryl sulfate and 124.5 grams deionized water to a container with magnetic stirring. 14.26 grams of MA-20 was charged to the vessel followed by 100 grams BA and then 87 grams MAA was added slowly to form a smooth, stable monomer emulsion. The solution was added to a syringe for addition to the kettle. A kettle catalyst charge was prepared adding 0.29 grams sodium persulfate and 10.7 grams of deionized water and set aside. A kettle activator solution of 0.06 grams isoascorbic acid and 13.3 grams deionized water was prepared and set aside.

A cofeed catalyst solution of 0.595 grams sodium persulfate and 39.3 grams deionized water was prepared and added to syringe for the addition to the kettle. A cofeed activator solution of 0.119 grams of isoascorbic acid and 40 grams of deionized water was prepared and added to syringe for the addition to the kettle.

After 1 hour sparge at 45° C., 5.73 grams of 28% sodium lauryl sulfate was charged to the kettle with 4 grams of deionized water rinse. At 45° C., 0.8 grams of a 0.15% iron sulfate heptahydrate solution was added to the kettle, followed immediately by the isoascorbic acid kettle activator then the sodium persulfate catalyst solution. The monomer emulsion cofeed and the catalyst cofeeds were started simultaneously. The monomer emulsion cofeed was added at a rate of 3.7 grams/minute over 90 minutes. The cofeed activator and catalyst solutions were added at a rate of 0.4 grams/minute for a total of 100 minutes. At the completion of the cofeeds the reaction was held for 10 minutes at 45° C.

During the hold, 2 identical sets of chaser solutions were prepared. 0.071 grams isoascorbic acid was dissolved in 6.6 grams deionized water and 0.15 grams of a 70% tert-butyl hydroperoxide was mixed with 6.6 grams deionized water and both sets were set aside. At the end of the hold, the first set of chaser solutions were added as shots to the kettle and held 20 minutes. After the hold, chaser set 2 was added as shots and held for 20 minutes. At the completion of the chasers the reaction was then allowed to cool to room temperature and filtered through a 100 mesh bag. The final emulsion polymer had a solids content of 25.0%

### EXAMPLES

| poly. | | | polym. |
|---|---|---|---|
| # | composition (wt % of total monomers) | Mw | process |
| A | 50 EA/40 MAA/10 MA-20 (Comparative) | 706,530 | thermal |
| B | 24 EA/24 BA/42 MAA/10 MA-20 | 637,780 | thermal |
| C | 36 EA/12 BA/42 MAA/10 MA-20 | 534,960 | thermal |
| D | 36 EA/12 BMA/42 MAA/10 MA-20 | 609,900 | thermal |
| E | 36 EA/12 EHA/42 MAA/10 MA-20 | 687,730 | thermal |
| F | 36 EA/12 LMA/42 MAA/10 MA-20 | 202,340 | thermal |
| G | 23.2 EA/11.6 BA/11.6 EA/43.9 MAA/9.7 | | thermal |
| | MA-20 | | |
| H | 20 EA/20 BA/45 MAA/15 MA-20 | | thermal |
| I | 44 EA/4 EHA/42 MAA/10 MA-20 | | thermal |
| J | 39 EA/9 EHA/42 MAA/10 MA-20 | | thermal |
| K | 60 MA/10 MAA/20 AA/10 MA-22 | | redox |
| | (Comparative) | | |
| L | 40 MA/20 BA/10 MAA/20 AA/10 MA-22 | | redox |
| M | 50 EA/45 MAA/5 MA-20 (Comparative) | | redox |
| N | 50 BA/45 MAA/5 MA-20 | | redox |
| O | 55 EA/45 MAA (Comparative) | | thermal |
| P | 35 EA/20 BA/45 MAA | | thermal |
| Q | 40 EA/15 EHA/45 MAA | | thermal |
| R | 52 EA/10 MAA/20 AA/18 MA-20//0.116 | | redox |
| | TMPDE-90/0.1 nDDM | | |
| S | 26 EA/26 BA/10 MAA/20 AA/18 MA-20// | | redox |
| | 0.116 TMPDE-90/0.1 nDDM | | |

Acrylic monomers mentioned herein include acrylic acid (AA), methacrylic acid (MAA), ethyl acrylate (EA), n-butyl acrylate (BA), n-butyl methacrylate (BMA), 2-ethylhexyl acrylate (EHA), methyl acrylate (MA), lauryl methacrylate (LMA), MA-20 (methacrylate ester of a 20 mole ethoxylate of a C₁₆-C₁₈ alcohol, MA-22 (methacrylate ester of a 25 mole ethoxylate of a C₂₋₂ alcohol. n-dodecyl mercaptan (nDDM) often is used as a chain transfer agent. Amount of each monomer is calculated as a percent of total monomer amounts (without nDDM) and the amount of nDDM also is given as percent of total monomers, i.e., monomer percentages add to 100 without nDDM.

Witco 90 Flake=anionic sodium dodecyl benzene sulfonate (Linear Alkyl Benzene Sulfonate; LABS), 90% actives; NEODOL 25-7 Alcohol Ethoxylate (AE)=nonionic C₁₂-C₁₅-alcohol with an average of approximately 7 moles of ethylene oxide per mole of alcohol, 100% actives. Alkyl ethoxylate sulfate, metal salt (AEOS) examples include: WITCOLATE LES-60C=anionic C₁₂-C₁₄ (3 Moles EO) Sodium Sulfate, 60% actives EMPICOL ESB 70=anionic C₁₂-C₁₄ (2 Moles EO) Sodium Sulfate, 70% actives.

The formulation was made in the following six steps ensure a homogeneous liquid.

| Steps | | |
|---|---|---|
| 1 | Weigh LABS/AEOS/AE | Mix at 3540 rpm for 1 minute* |
| 2 | Add propylene glycol and | Mix at 3540 rpm for 1 minute |
| | ethanol | |
| 3 | Add D.I. water | Mix at 3540 rpm for 1 minute |
| 4 | Add citric acid solution | Mix at 3540 rpm for 1 minute |
| 5 | Add rheology modifier | Mix at 3540 rpm for 1 minute |
| 6 | Add sodium hydroxide solution | Mix at 3540 rpm for 1 minute |

*Using dual axis speed mixer (setting at 33 with 3540 rpm)

Surfactants were added into a plastic Max100 speed mixer cup and blended in a Speedmixer (FlackTek SpeedMixer™, Model DAC 150 FVZ-K) at 3540 rpm for 1 minute. Then, propylene glycol and ethanol were added and mixed again. Next, Citric acid (Aqueous 35 wt %) was added and mixed. Rheology modifier was added and mixed. Finally, sodium hydroxide (Aqueous 30 wt %) was added and mixed. Samples were stored at room temperature overnight and were re-mixed in the Speedmixer at 3540 rpm for 1 minute on the second day.

On the third day, all the samples were first re-mixed in a Speedmixer at 3540 rpm for 1 minute. Then the pH of each sample was measured using Orion 4 Star pH meter with a semi-micro glass combination electrode (Thermo scientific ROSS 8103BN). This pH meter was calibrated with pH 4, 7, 10 buffers before use. Then the pH of each sample was adjusted to 8.2 to 8.4 using either sodium hydroxide or citric acid solutions.

Approximately 0.7-mL sample was dispensed into a 1-mL glass vial and capped for PICA II clarity measurement. Approximately 4-5-mL sample was poured or added using pipette into a PPR test tube for automated Anton Paar rheology measurement. Be careful not to introduce any bubbles to the vial.

### Characterizations:

Rheology Testing was performed using Automated Anton Paar M-301 Rheometer. The viscosity was measured at shear rates from 0.1 to 117 s⁻¹ at temperatures of 20 and 40° C. The clarity and phase stability were measured at temperature 5, 20, and 45° C. using Phase Identification and Characterization Apparatus (PICA). Images of each sample were acquired using both standard side lighting and plane polarized lighting methods. The Epoch (Symyx, CA) software was used to process the clarity and number of phases.

### Comparative Example #1

In a surfactant system of 33% of surfactant with three surfactant LABS/AEOS/AE ratio of 0.333/0.333/0.333, 1.25% of polymer A was added. The formulation was adjusted to pH of 8.2. The pour shear viscosity (shear rate of 20 s⁻¹) at 20 and 40° C. are 595 and 223 cP and the clarity at 5, 20, and 45° C. are 23, 17, and 12 respectively.

### Examples 1-5

In the same surfactant system as Comparative Example #1, 1.25% of a novel rheology modifier was added. The formulation was adjusted to pH of 8.2. The pour shear viscosity (shear rate of 20 s⁻¹) at 20 and 40° C. and the clarity at 5, 20, and 45° C. were measured. Results are shown in Table 3. Novel rheology modifiers have significantly higher viscosity than the polymer A control. For example, Exp. #1 has 40% increase in viscosity than polymer A. Novel rheology modifiers have higher clarity (low clarity number) than the polymer A control at all three tested temperatures.

### Examples 1-5 Formulations: 33% Surfactant Liquid Laundry Formulation (Center Point)

| Components | Active Amounts | Wet Weight (g) |
|---|---|---|
| LABS (90%) | 11.0% | 6.1050 |
| AEOS (70%) | 11.0% | 7.8729 |
| AE (100%) | 11.0% | 5.4945 |
| Propylene glycol (100%) | 7.9% | 3.9500 |
| Ethanol (100%) | 3.4% | 1.7000 |
| D.I. H2O | Balance | 15.9606 |
| Citric Acid (35%) | 2.6% | 3.7143 |
| Polymer A or other (~30%) | 1.25% | 2.0833 |
| NaOH (30%) | to get pH 8.3 | |

Phase Identification and Characterization Apparatus (PICA II) was used to measure clarity and phase stability, except where “NTU” (Nephelometric Turbidity Units) is stated. Epoch (Symyx, CA) software “PICA II V10.0.5—Current Version” was used. Each sample in a capped, 1 mL glass vial was transferred from a 96-well aluminum plate to an enclosure with a robotic gripper arm. In the enclosure, images were acquired with both standard white light and plane polarized light using a Canon Rebel XTi camera. PICA II provides a relative turbidity comparison between samples, but not the absolute turbidity in nephelometric turbidity units (NTU). The PICA II clarity number has no direct correlation to NTU. However, both tests give similar conclusion for a given sample. A PICA II clarity value of 20 or less indicates that a sample is visually clear. The higher the clarity number is, the more cloudy the formulation is. PICA II also provides visual images in addition to the clarity data.

### Pour Shear Viscosity and Clarity Comparisons of Exs. 1-5 and Comparative Ex. #1

| | | Viscosity | Viscosity | Clarity | Clarity | Clarity |
|---|---|---|---|---|---|---|
| | poly- | 20° C. | 40° C. | at | at | at |
| | mer | (cP) | (cP) | 5° C. | 20° C. | 45° C. |
| Comp. | A | 595 | 223 | 23 | 17 | 12 |
| Ex. #1 | | | | | | |
| Ex. #1 | B | 833 | 303 | 10 | 4 | 4 |
| Ex. #2 | C | 670 | 274 | 13 | 6 | 5 |
| Ex. #3 | D | 693 | 253 | 13 | 9 | 7 |
| Ex. #4 | E | 789 | 300 | 8 | 5 | 4 |
| Ex. #5 | F | 763 | 267 | 16 | 6 | 5 |

Base formulation: LABS/AEOS/AE (0.333, 0.334, 0.333), total surfactant concentration 33%, POLYMER amount 1.25%

### Comparative Example #2

In a surfactant system of 36% of surfactant with three surfactant LABS/AEOS/AE ratio of 0.270/0.348/0.382, 0.8% of polymer A was added. The formulation was adjusted to pH of 8.3. The pour shear viscosity (shear rate of 20 s⁻¹) at 20 and 40° C. are 412 and 132 cP and the clarity at 5, 20, and 45° C. are 25, 22 and 14, respectively.

### Examples 6-8

In the same surfactant system as Comparative Example #1, 0.8% of a novel rheology modifier was added. The formulation was adjusted to pH of 8.3. The pour shear viscosity (shear rate of 20 s⁻¹) at 20 and 40° C. and the clarity at 5, 20, and 45° C. were measured. Results are shown in Table 4. Novel rheology modifiers have significantly higher viscosity than the Polymer A control. For example, Exp. #7 has a 32% increase in viscosity than Polymer A. Novel rheology modifiers have higher clarity (low clarity number) than the Polymer A control at all three tested temperatures.

### Examples 6-8 Formulations: 36% Surfactant Liquid Laundry Formulation.

| Components | Active Amounts | Wet Weight (g) |
|---|---|---|
| LABS (90%) | 9.7% | 5.4000 |
| AEOS (70%) | 12.5% | 8.9486 |
| AE (100%) | 13.8% | 6.8760 |
| Propylene glycol (100%) | 7.9% | 3.9500 |
| Ethanol (100%) | 3.4% | 1.7000 |
| D.I. H2O | Balance | 15.1001 |
| Citric Acid (35%) | 2.6% | 3.7143 |
| Polymer A or other (~30%) | 0.80% | 1.3333 |
| NaOH (30%) | to get pH 8.3 | |

### Pour Shear Viscosity and Clarity (PICA) Comparisons of Exs. 1-5 and Comparative Ex. #2

| | | | | Clarity | Clarity | Clarity |
|---|---|---|---|---|---|---|
| | poly- | Viscosity | Viscosity | at | at | at |
| | mer | 20° C. | 40° C. | 5° C. | 20° C. | 45° C. |
| Comp. | A | 412 | 132 | 25 | 22 | 14 |
| Ex. #2 | | | | | | |
| Exp. #6 | B | 491 | 163 | 7 | 5 | 4 |
| Exp. #7 | E | 545 | 175 | 6 | 5 | 4 |
| Exp. #8 | F | 511 | 161 | 9 | 7 | 5 |

Base formulation: LABS/AEOS/AE (0.270, 0.348, 0.382), total surfactant concentration 36%, polymer amount 0.8%

### Comparative Example #3

In a surfactant system of 33% of surfactant with three surfactant LABS/AEOS/AE ratio of 0.60/0.02/0.38, 01.2% of Polymer A was added. The formulation was adjusted to pH of 8.3. The pour shear viscosity (shear rate of 20 s⁻¹) at 20 and 40° C. are 389 and 170 cP and the clarity at 5, 20, and 45° C. are 41, 38, and 27 respectively.

### Examples 9-10

In the same surfactant system as Comparative Example #3, 1.2% of a novel rheology modifier was added. The formulation was adjusted to pH of 8.3. The pour shear viscosity (shear rate of 20 s⁻¹) at 20 and 40° C. and the clarity at 5, 20, and 45° C. were measured. Results are shown in Table 5. Novel rheology modifiers have significantly higher viscosity than the Polymer A control. For example, Exp. #8 has a 27% increase in viscosity over Polymer A. Novel rheology modifiers have higher clarity (low clarity number) than the Polymer A control at all three tested temperatures.

Examples 9-10 Formulations: 33% Surfactant Liquid Laundry Formulation with Low AEOS

| Components | Active Amounts | Wet Weight (g) |
|---|---|---|
| LABS (90%) | 19.8% | 11.0000 |
| AEOS (70%) | 0.7% | 0.4714 |
| AE (100%) | 12.5% | 6.2700 |
| Propylene glycol (100%) | 7.9% | 3.9500 |
| Ethanol (100%) | 3.4% | 1.7000 |
| D.I. H2O | Balance | 17.7906 |
| Citric Acid (35%) | 2.6% | 3.7143 |
| polymer A or other (~30%) | 1.20% | 2.0000 |
| NaOH (30%) | to get pH 8.3 | |

### Pour Shear Viscosity and Clarity Comparisons of Exs. 1-5 and Comparative Exp. #2

| | | | | Clarity | Clarity | Clarity |
|---|---|---|---|---|---|---|
| polymer | poly- | Viscosity | Viscosity | at | at | at |
| Type | mer | 20° C. | 40° C. | 5° C. | 20° C. | 45° C. |
| Comp. | A | 389 | 170 | 41 | 38 | 27 |
| Ex. #3 | | | | | | |
| Ex. #9 | B | 493 | 220 | 5 | 6 | 5 |
| Ex. #10 | E | 487 | 214 | 7 | 6 | 6 |

Base formulation: LABS/AEOS/AE (0.6, 0.02, 0.38), total surfactant concentration 33%, polymer amount 1.2%

### Polymers A, B, G and H at 0.5% in a 36% Surfactant Formulation

36% Surfactant Liquid Laundry Formulation (adjusted to pH 8.2)

| Chemical | Wt % Added |
|---|---|
| NANSA SS/U −30% Active (C12-C14 Linear | 30.0 [9% actives] |
| alkyl benzene sulfonate, sodium) | |
| EMPICOL ESB 70% Active (C12-C14 Sodium | 17.1 [12% actives] |
| Lauryl Ether Sulfate, 2-3 EO) | |
| Alcohol Ethoxylate (NEODOL 25-7; C12-15 | 15.0 [15% actives] |
| with ~7 mole ethoxylate) | |
| Poly Propylene Glycol 400 | 4.0 |
| Ethanol/Fragrance | 0.0 |
| NaCl | 0.0 |
| Sodium Citrate | 3.0 |
| Water | 20.9 |
| Polymer + water | 10 |

polymer

| | | | |
|---|---|---|---|
| A (Comp.) | B | G | H |

| | |
|---|---|
| shear rate (sec⁻¹) | viscosity (CPS) |

| | | | | |
|---|---|---|---|---|
| 20 | 511 | 710 | 650 | 585 |
| 10 | 515 | 724 | 663 | 594 |
| 1 | 522 | 757 | 700 | 615 |
| Clarity (NTU) | 116.8 | 23.5 | 3.5 | 35.1 |

The above rheological data were collected at 20° C. using a TA Instruments AR2000 rheometer. The NTU was measured at room temperature using a nephelometer.

### Rheology Modifiers in Sulfate Free Shampoo Formulations

The formulation is as follows:
Sulfate free shampoo contains 10% of disodium laureth sulfosuccinate and 2% of cocamidopropyl betaine (total surfactant 12%).

### Formulation of Sulfate Free Shampoos

| | | Active | Active | Wet |
|---|---|---|---|---|
| Chemicals | Compositions | % | Amount % | Weight (g) |
| D.I Water | | 100% | balance | 47.77 |
| polymer A or other | | 30% | 1.2% | 3.00 |
| Triethanolamine | Triethanolamine | 100% | 0.4% | 0.30 |
| Chemccinate DSLS | Disodium Laureth | 39% | 10% | 19.28 |
| | Sulfosuccinate | | | |
| Triethanolamine | Triethanolamine | 100% | 0.5% | 0.38 |
| Chembetaine C | Cocamidopropyl | 35% | 2% | 4.28 |
| | Betaine | | | |

Triethanol amine added to get pH 7.0

At pH 7, novel rheology modifiers with more hydrophobic backbones do not perform as well as Polymer A at thickening the 12% of sulfate free surfactants. Except polymer F having higher clarity number (cloudy), the other novel rheology modifiers have similar clarity to the Polymer A.

### Viscosity and PICA Clarity Number

| | Viscosity at 20 s⁻¹ | | PICA II |
|---|---|---|---|
| polymer | 20° C. | 40° C. | Clarity |
| none | 2 | 2 | 4 |
| A | 1611 | 555 | 6 |
| B | 470 | 255 | 6 |
| C | 793 | 269 | 4 |
| D | 661 | 295 | 5 |
| E | 587 | 206 | 10 |
| F | 279 | 119 | 32 |

### Influence of EHA Amount of Rheology Modifiers on the Viscosity and Clarity

Formulation is the same as listed above for 33% Surfactant Liquid Laundry Formulation, Center Point

### Viscosity and PICA Clarity Number of EHA Levels

| | Viscosity at 20 s⁻¹ | | PICA II |
|---|---|---|---|
| polymer | 20° C. | 40° C. | Clarity |
| A | 595 | 223 | 17 |
| I | 677 | 257 | 10 |
| J | 815 | 317 | 4 |
| E | 789 | 300 | 4 |

Base formulation: LABS/AEOS/AE (0.333, 0.334, 0.333), total surfactant concentration 33%, polymer amount 1.25%
The highest viscosity is for polymer J rheology modifier with 9% of EHA. At 4% of EHA, the viscosity of polymer I is still higher than that of Polymer A and the clarity is also better.

### Influence of Polymer K Variant on the Viscosity and Clarity

Formulation is the same as listed above for 33% Surfactant Liquid Laundry Formulation, Center Point
Viscosity and PICA Clarity Number of Polymer K (Comp.) with BA (SIPOMER BEM Phobe)

| | Viscosity at 20 s⁻¹ | | PICA II |
|---|---|---|---|
| polymer | 20° C. | 40° C. | Clarity |
| K | 335 | 125 | 50 |
| L | 738 | 276 | 4 |

Base formulation: LABS/AEOS/AE (0.333, 0.334, 0.333), total surfactant concentration 33%, polymer amount 1.25%
For polymer K-based rheology modifier with 10% Sipomer phobe, the viscosity of polymer L with 20% BA is more than twice the viscosity of polymer K without BA. In addition, the clarity of polymer L (20%) BA is much better than that of polymer K.

### Influence of Total Surfactant Amount on the Viscosity and Clarity (10 & 15%)

Formulations contain 10% Surfactant with LABS/AEOS/AE ratio of 1/1/1 (3.33%, 3.34%, and 3.33%) and rheology modifier level of 1.25%.

### Viscosity and PICA Clarity Number of 10% Surfactant Concentration

| | Viscosity at 20 s⁻¹ | | PICA II |
|---|---|---|---|
| polymer | 20° C. | 40° C. | Clarity |
| Polymer A | 786 | 205 | 5 |
| B | 642 | 170 | 9 |
| C | 642 | 159 | 6 |
| D | 758 | 185 | 8 |
| E | 614 | 162 | 23 |
| F | 351 | 98 | 76 |

Base formulation: LABS/AEOS/AE (0.333, 0.334, 0.333), total surfactant concentration 10%, polymer amount 1.25%
At total surfactant concentration of 10%, Polymer A has higher viscosity and better clarity than novel rheology modifiers with increased hydrophobic backbone.
Formulations contain 15% Surfactant with LABS/AEOS/AE ratio of 1/1/1 (5%, 5%, and 5%) and rheology modifier level of 1.25%.

### Viscosity and PICA Clarity Number of 15% Surfactant Concentration

| | Viscosity at 20 s⁻¹ | | PICA II |
|---|---|---|---|
| polymer | 20° C. | 40° C. | Clarity |
| A | 791 | 229 | 10 |
| B | 878 | 254 | 5 |
| C | 765 | 220 | 5 |
| D | 826 | 210 | 5 |
| E | 838 | 237 | 9 |
| F | 474 | 118 | 30 |

Base formulation: LABS/AEOS/AE (0.333, 0.334, 0.333), total surfactant concentration 15%, polymer amount 1.25%
At total surfactant concentration of 15%, several novel rheology modifiers (B, D, E) with increased hydrophobic backbone have comparable to or higher viscosity and better clarity than Polymer A control.

### Viscosity and Clarity Number of Polymer M (Comp.) and Polymer N

| | Viscosity at 20 s⁻¹ | NTU |
|---|---|---|
| polymer | 20° C. | Clarity |
| M | 553 | 860 |
| N | 792 | 2 |

Base formulation: LABS/AEOS/AE (0.333, 0.334, 0.333), total surfactant concentration 36%, polymer amount 0.5%
Effect of Polymers Having No Alkyl-Capped Polyalkylene Oxide Monomer Residues (Polymers 0, P and Q) at 1% in a 26% Surfactant Formulation (Described Below for Polymers R and S, Although R and S were Present at 2%)

| | POLYMER | | | |
|---|---|---|---|---|
| | A (Comp.) | O | P | Q |
| | viscosity | viscosity | viscosity | viscosity |
| shear rate (sec⁻¹) | (CPS) | (CPS) | (CPS) | (CPS) |
| 100 | 1127 | 281 | 684 | 1200 |
| 50 | 1214 | 281 | 740 | 1310 |
| 10 | 1470 | 287 | 874 | 1667 |
| 1.2 | 1834 | 295 | 1010 | 2030 |
| 0.1 | 2295 | 310 | 1068 | 2295 |
| Clarity (NTU) | 36.1 | 33 | 2.6 | 2.9 |

The above rheological data were collected at 20° C. using a TA Instruments AR2000 rheometer. The NTU was measured at room temperature using a nephelometer.

### Effect of Surfactant and Polymer Concentration on Phase Separation

| Parameter | Comments | Min | Max |
|---|---|---|---|
| Surfactant blend (LABS, AEOS, AE) | | See table below | |
| Surfactant concentration | Three levels | 22%, 33%, 44% | |
| polymer (solids basis) | | 0.5% | 2% |
| Ethanol | Fixed | 3.40% | 3.40% |
| Propylene glycol | Fixed | 7.90% | 7.90% |
| Water | DI water | as needed | |
| Citric acid (MW = 192.12) | Fixed | 2.6% | 2.6% |
| Sodium hydroxide | Variable | to pH 8.3 | |
| pH | Fixed (+/−0.1) | 8.3 | 8.3 |

| | |
|---|---|
| Order of addition | surfactant blend > |
| | prop. glycol > ethanol > |
| | water > citric acid or |
| | sodium citrate > |
| | polymer > caustic |

| | % | % | % | % | % | viscosity | clarity | # |
|---|---|---|---|---|---|---|---|---|
| poly. | LABS | AEOS | AE | surf. | poly. | (20 s−1) | 8d | phases |
| A | 16.67 | 66.67 | 16.67 | 33 | 1.25 | 1794 | 7 | 1 |
| A | 0.00 | 100.0 | 0.00 | 22 | 0.50 | 225 | 8 | 1 |
| A | 50.00 | 50.00 | 0.00 | 44 | 2.00 | 2288 | 6 | 1 |
| A | 33.33 | 33.33 | 33.33 | 33 | 1.25 | 519 | 17 | 1 |
| A | 0.00 | 50.00 | 50.00 | 44 | 2.00 | 497 | 50 | 2 |
| A | 50.00 | 50.00 | 0.00 | 22 | 0.50 | 246 | 11 | 1 |
| A | 50.00 | 0.00 | 50.00 | 44 | 0.50 | 205 | 205 | 2 |
| A | 33.33 | 33.33 | 33.33 | 22 | 2.00 | 1385 | 10 | 1 |
| A | 50.00 | 50.00 | 0.00 | 22 | 2.00 | 1827 | 6 | 1 |
| A | 33.33 | 33.33 | 33.33 | 22 | 0.50 | 256 | 21 | 1 |
| A | 16.67 | 16.67 | 66.67 | 33 | 1.25 | 457 | 50 | 2 |
| A | 0.00 | 0.00 | 100.0 | 22 | 0.50 | 497 | 9 | 1 |
| A | 100.0 | 0.00 | 0.00 | 44 | 2.00 | 3150 | 200 | 2 |
| A | 0.00 | 0.00 | 100.0 | 44 | 0.50 | 413 | 187 | 1 |
| A | 0.00 | 50.00 | 50.00 | 22 | 0.50 | 470 | 20 | 1 |
| A | 100.0 | 0.00 | 0.00 | 22 | 2.00 | 1573 | 7 | 1 |
| A | 33.33 | 33.33 | 33.33 | 44 | 2.00 | 745 | 12 | 1 |
| A | 33.33 | 33.33 | 33.33 | 44 | 0.50 | 245 | 11 | 1 |
| A | 0.00 | 0.00 | 100.0 | 22 | 2.00 | 3189 | 4 | 1 |
| A | 33.33 | 33.33 | 33.33 | 33 | 1.25 | 577 | 16 | 1 |
| A | 100.0 | 0.00 | 0.00 | 44 | 0.50 | 558 | 235 | 2 |
| A | 50.00 | 0.00 | 50.00 | 22 | 0.50 | 171 | 42 | 1 |
| A | 66.67 | 16.67 | 16.67 | 33 | 1.25 | 639 | 11 | 1 |
| A | 0.00 | 100.0 | 0.00 | 44 | 2.00 | 12358 | 206 | 1 |
| A | 50.00 | 0.00 | 50.00 | 22 | 2.00 | 863 | 21 | 1 |
| A | 0.00 | 50.00 | 50.00 | 22 | 2.00 | 3324 | 12 | 1 |
| A | 0.00 | 50.00 | 50.00 | 44 | 0.50 | 484 | 130 | 2 |
| A | 33.33 | 33.33 | 33.33 | 33 | 1.25 | 584 | 16 | 1 |
| A | 50.00 | 50.00 | 0.00 | 44 | 0.50 | 601 | 4 | 1 |
| A | 0.00 | 100.0 | 0.00 | 44 | 0.50 | 22714 | 206 | 1 |
| A | 50.00 | 0.00 | 50.00 | 44 | 2.00 | 158 | 150 | 2 |
| A | 100.0 | 0.00 | 0.00 | 22 | 0.50 | 169 | 14 | 1 |
| A | 0.00 | 0.00 | 100.0 | 44 | 2.00 | 1183 | 185 | 1 |
| A | 33.33 | 33.33 | 33.33 | 33 | 1.25 | 574 | 17 | 1 |
| A | 0.00 | 100.0 | 0.00 | 22 | 2.00 | 3010 | 5 | 1 |
| B | 16.67 | 66.67 | 16.67 | 33 | 1.25 | 1947 | 4 | 1 |
| B | 0.00 | 100.0 | 0.00 | 22 | 0.50 | 312.9 | 3 | 1 |
| B | 50.00 | 50.00 | 0.00 | 44 | 2.00 | 2703 | 4 | 1 |
| B | 33.33 | 33.33 | 33.33 | 33 | 1.25 | 783 | 4 | 1 |
| B | 0.00 | 50.00 | 50.00 | 44 | 2.00 | 1126 | 70 | 2 |
| B | 50.00 | 50.00 | 0.00 | 22 | 0.50 | 331 | 5 | 1 |
| B | 50.00 | 0.00 | 50.00 | 44 | 0.50 | 175 | 210 | 2 |
| B | 33.33 | 33.33 | 33.33 | 22 | 2.00 | 2087 | 4 | 1 |
| B | 50.00 | 50.00 | 0.00 | 22 | 2.00 | 3067 | 5 | 1 |
| B | 33.33 | 33.33 | 33.33 | 22 | 0.50 | 343 | 3 | 1 |
| B | 16.67 | 16.67 | 66.67 | 33 | 1.25 | 480 | 32 | 1 |
| B | 0.00 | 0.00 | 100.0 | 22 | 0.50 | 497 | 4 | 1 |
| B | 100.0 | 0.00 | 0.00 | 44 | 2.00 | 6781 | 220 | 2 |
| B | 0.00 | 0.00 | 100.0 | 44 | 0.50 | 377 | 215 | 2 |
| B | 0.00 | 50.00 | 50.00 | 22 | 0.50 | 481 | 5 | 1 |
| B | 100.0 | 0.00 | 0.00 | 22 | 2.00 | 1733 | 8 | 1 |
| B | 33.33 | 33.33 | 33.33 | 44 | 2.00 | 843 | 4 | 1 |
| B | 33.33 | 33.33 | 33.33 | 44 | 0.50 | 254 | 4 | 1 |
| B | 0.00 | 0.00 | 100.0 | 22 | 2.00 | 3403 | 4 | 1 |
| B | 33.33 | 33.33 | 33.33 | 33 | 1.25 | 789 | 4 | 1 |
| B | 100.0 | 0.00 | 0.00 | 44 | 0.50 | 655 | 200 | 2 |
| B | 50.00 | 0.00 | 50.00 | 22 | 0.50 | 183 | 6 | 1 |
| B | 66.67 | 16.67 | 16.67 | 33 | 1.25 | 753 | 4 | 1 |
| B | 0.00 | 100.0 | 0.00 | 44 | 2.00 | 14894 | 221 | 1 |
| B | 50.00 | 0.00 | 50.00 | 22 | 2.00 | 1191 | 4 | 1 |
| B | 0.00 | 50.00 | 50.00 | 22 | 2.00 | 3035 | 4 | 1 |
| B | 0.00 | 50.00 | 50.00 | 44 | 0.50 | 505 | 150 | 2 |
| B | 33.33 | 33.33 | 33.33 | 33 | 1.25 | 755 | 4 | 1 |
| B | 50.00 | 50.00 | 0.00 | 44 | 0.50 | 620 | 5 | 1 |
| B | 0.00 | 100.0 | 0.00 | 44 | 0.50 | 29829 | 221 | 1 |
| B | 50.00 | 0.00 | 50.00 | 44 | 2.00 | 170 | 210 | 2 |
| B | 100.0 | 0.00 | 0.00 | 22 | 0.50 | 219 | 11 | 1 |
| B | 0.00 | 0.00 | 100.0 | 44 | 2.00 | 923 | 175 | 2 |
| B | 33.33 | 33.33 | 33.33 | 33 | 1.25 | 756 | 4 | 1 |
| B | 0.00 | 100.0 | 0.00 | 22 | 2.00 | 3410 | 4 | 1 |

### Effect of Crosslinking

Samples of polymers R and S were formulated as follows.

### Formula:

| | | Mass | |
|---|---|---|---|
| | | Charge | % |
| | % | (100 gram | Surfactant |
| Ingredients (in order of addition) | Active | Basis) | Actives |
| Deionized Water | | 50.5 | |
| Linear Alkyl Benzene Sulfonate | 90 | 7.78 | 7 |
| (WITCO 90 Flake) | | | |
| Sodium Alcohol Ethoxylate Sulfate | 60 | 16.67 | 10 |
| (WITCOLATE LES-60C) | | | |
| Sodium Lauryl Ether Sulfate | 70 | 7.83 | 5.48 |
| (EMPICOL ESB 70) | | | |
| Propylene Glycol | 100 | 5 | |
| Ethanol | 100 | 2.5 | |
| Alcohol Ethoxylate | 100 | 2.64 | 2.64 |
| (NEODOL 25-7) | | | |
| Polymer | 29 | 6.9 | |
| 10% NaOH | 10 | 0.18 | |
| TOTAL (pH = 9.0) | | 100.0 | 25.12 |

Viscosity and clarity were measured as described above, with the results presented in the table below

POLYMER

| | R (Comp.) | S |
|---|---|---|
| shear rate (sec⁻¹) | viscosity (CPS) | viscosity (CPS) |
| 45 | 4042 | 3076 |
| 22 | 5007 | 4022 |
| 12 | 5721 | 5696 |
| 1 | 13260 | 12760 |
| 0.08 | 58870 | 72640 |
| 0.0025 | 402000 | 563800 |
| 0.001 | 513000 | 651000 |
| 0.00031 | 499000 | 559000 |
| Clarity (NTU) | 31.3 | 1.3 |

The above rheological data was collected at 20° C. using a TA Instruments AR2000 rheometer. The NTU was measured at room temperature using a nephelometer.

1. A detergent composition comprising: (a) from 14 to 50 wt % surfactants; and (b) from 0.05 to 4 wt % of at least one polymer comprising polymerized residues of: (i) 40 to 65 wt % C₁-C₁₈ alkyl (meth)acrylates; wherein at least 1/10 by weight of the C₁-C₁₈ alkyl (meth)acrylates is limited to C₄-C₁₈ alkyl (meth)acrylates; (ii) 25 to 55 wt % C₃-C₆ carboxylic acid monomers; and (iii) 0 to 20 wt % of monomers of structure H₂C═C(R)C(O)X(CH₂CH₂O)ₙ(CH(R′)CH₂O)ₘR″ or H₂C═C(R)C₆H₄C(CH₃)₂NHCO₂(CH₂CH₂O)ₙ(CH(R′)CH₂O)ₘR″; wherein X is O or NH, R is H or CH₃, R′ is C₁-C₂ alkyl; R″ is C₈-C₂₅ alkyl, C₈-C₁₆ alkylphenyl or C₁₃-C₃₆ aralkylphenyl; n is an average number from 6-100 and m is an average number from 0-50, provided that n≧m and m+n is 6-100.

2. The detergent composition of claim 1 which comprises from 20 to 50 wt % surfactants.

3. The detergent composition of claim 2 in which at least 2/10 by weight of the C₁-C₁₈ alkyl (meth)acrylates in the polymer is limited to C₄-C₁₈ alkyl (meth)acrylates.

4. The detergent composition of claim 3 comprising from 0.3 to 3 wt % of said polymer.

5. The detergent composition of claim 4 which comprises from 25 to 46 wt % surfactants.

6. The detergent composition of claim 5 in which the polymer comprises polymerized residues of: (i) 42 to 60 wt % C₁-C₁₈ alkyl (meth)acrylates; wherein at least 2/10 by weight of the C₁-C₁₈ alkyl (meth)acrylates is limited to C₄-C₈ alkyl (meth)acrylates; (ii) 28 to 58 wt % C₃-C₆ carboxylic acid monomers; and (iii) 0 to 12 wt % of monomers of structure H₂C═C(R)C(O)X(CH₂CH₂O)ₙ(CH(R′)CH₂O)ₘR″ or H₂C═C(R)C₆H₄C(CH₃)₂NHCO₂(CH₂CH₂O)ₙ(CH(R′)CH₂O)ₘR″; wherein X is O; R″ is C₁₂-C₂₂ alkyl; n is 15-30 and m is 0-5; and R′ and R are methyl.

7. The detergent composition of claim 1 in which the C₁-C₁₈ alkyl (meth)acrylates are limited to C₁-C₈ alkyl (meth)acrylates at least 2/10 by weight of the C₁-C₈ alkyl (meth)acrylates is limited to C₄-C₈ alkyl (meth)acrylates.

8. The detergent composition of claim 7 comprising from 0.3 to 3 wt % of said polymer.

9. The detergent composition of claim 8 in which the polymer comprises polymerized residues of: (i) 42 to 60 wt % C₁-C₁₈ alkyl (meth)acrylates; (ii) 28 to 58 wt % C₃-C₆ carboxylic acid monomers; and (iii) 0 to 12 wt % of monomers of structure H₂C═C(R)C(O)X(CH₂CH₂O)ₙ(CH(R′)CH₂O)ₘR″ or H₂C═C(R)C₆H₄C(CH₃)₂NHCO₂(CH₂CH₂O)ₙ(CH(R′)CH₂O)ₘR″; wherein X is O; R″ is C₁₂-C₂₂ alkyl; n is 15-30 and m is 0-5; and R′ and R are methyl.

10. The detergent composition of claim 9 in which at least 3/10 by weight of the C₁-C₈ alkyl (meth)acrylates is limited to C₄-C₈ alkyl (meth)acrylates.
